(19) United States
(12) Patent Application Publication
(10) Pub. No.: US 2011/0139472 A1
(43) Pub. Date: Jun. 16, 2011

(54) METHOD OF MACHINING WITH TOOL UNIT

(76) Inventor: Ulrich Bohne, Kohlberg (DE)

(21) Appl. No.: 13/031,436

(22) Filed: Feb. 21, 2011

Related U.S. Application Data
(62) Division of application No. 10/576,117, filed on Apr. 18, 2006.

(30) Foreign Application Priority Data
Sep. 13, 2004 (DE) 102004044135.9

(51) Int. Cl. B25F 5/00

(52) U.S. Cl. 173/1

(57) ABSTRACT

A method of machining includes using a tool unit for a handheld power tool having an oscillating output unit, a fastening element for attachment to the output unit, and a working edge transitioning into a lateral boundary line, being arc-shaped, and constituted by a circumference of a circle around whose circle point the fastening element is situated, situating at least one end of the working edge at an angle of substantially 90° in relation to a lateral boundary line on at least one side and constituting the working edge by a circumference section of a circle sector, situating each of two ends of the working edge at an angle in relation to a respective lateral boundary line extending in a radial direction, and in a vertical guide as the tool unit advances along the lateral boundary line situating a deepest point of an advancing motion is situated in a corner between the arc-shaped working edge and the lateral boundary line, and so that between a bottom of the guide and the lateral cut edge there is not any residual cross-section of the workpiece.

### CROSS-REFERENCE TO A RELATED APPLICATIONS

This application is a division of U.S. patent application Ser. No. 10/576,117 filed on Apr. 18, 2006. This U.S. patent application, whose subject matter is incorporated here by reference, provides the basis for a claim of priority of invention under 35 U.S.C. 119(a)-(d).

The invention described and claimed hereinbelow is also described in German Patent Application DE 10 2004 044 135.9 filed on Sep. 13, 2004. This German Patent Application, whose subject matter is incorporated here by reference, provides the basis for a claim of priority of invention under 35 U.S.C. 119(a)-(d).

### BACKGROUND OF THE INVENTION

The present invention relates to a method of machining with a tool unit of a handheld power tool.

It is known to perform machining with handheld power tools. In a handheld power tool with an oscillating output unit, for example embodied in the form of an output shaft, the shaft oscillates back and forth between two angular positions at a high frequency. This oscillation is transmitted to the tool unit attached to the output shaft. Depending on the tool unit, a handheld power tool of this kind can be used in a very wide variety of ways. It is thus possible to use the handheld power tool for sharpening, sawing, and grinding work pieces, for cutting work pieces, or for removing joining material, floor coverings, or tiles.

EP 0 881 023 A2 has disclosed a cutting and grinding tool for a handheld power tool equipped with an output shaft that executes an oscillating pivoting motion. The tool unit disclosed therein has a working edge composed of two or more cutting and/or grinding edges situated at an angle in relation to each other.

### SUMMARY OF THE INVENTION

The invention is based on a method of machining with a tool unit for a handheld power tool having an oscillating output unit, having a fastening means for attachment to the output unit, and having a working edge that transitions into a lateral boundary line.

The method of machining in accordance with the present invention includes the steps of providing a tool unit for a handheld power tool having an oscillating output unit, a fastening means for attachment to the output unit, and a working edge transitioning into a lateral boundary line, being arc-shaped, and constituted by a circumference of a circle around whose circle point the fastening means is situated; situating at least one end of the working edge at an angle of substantially 90° in relation to a lateral boundary line on at least one side and constituting the working edge by a circumference section of a circle sector, situating each of two ends of the working edge at an angle in relation to a respective lateral boundary line extending in a radial direction; and in a vertical guide as the tool unit advances along the lateral boundary line situating a deepest point of an advancing motion in a corner between the arc-shaped working edge and the lateral boundary line, and so that between a bottom of the guide and the lateral cut edge there is not any residual cross-section of the workpiece.

According to the present invention, a uniform cut in a work piece can be produced with a uniform stress on the working edge. The arc-shaped working edge is used to machine the work piece. The arc shape not only permits the tool unit to advance laterally, perpendicular to the cutting direction but also, by simply changing the attitude of the handheld power tool, permits the tool unit to be used in almost any way to machine the work piece, in particular for grinding, cutting, sawing, clearing, or disk cutting. The tool unit does not need to be changed to accomplish this.

In an advantageous embodiment of the present invention, the working edge is situated at an angle of less than or equal to 95° in relation to the lateral boundary line on at least one side. With a tool unit designed in this fashion, in a vertical guide, as the tool unit advances along the lateral boundary line, the deepest point of the advancing motion is situated in the corner between the arc-shaped working edge and the lateral boundary line. Between the bottom of the guide and the lateral cut edge, there is no longer any residual cross-section of the work piece since the cutting action is executed here, too. It is not necessary to penetrate deeper than the thickness of the work piece in order to cut through part of a work piece.

The attaching means serves to transmit a working motion. The working edge can extend at an angle in relation to the lateral boundary line. The attaching means can be embodied in almost any way. Thus, for example, a rod-shaped design known from drill attachments is conceivable, in which the rod is attached to the drive shaft by means of a rotary chuck, a screw chuck, or a quick-release chuck. It is also possible, however, to use a burr connection, a clamped connection, or a screw connection. In particular, it is also possible to provide an opening in the tool unit, which accommodates the output shaft and serves to connect the tool unit to this shaft.

Essentially, the arc of the working edge can be embodied in almost any form; in particular, it is conceivable to embody it in a parabolic, hyperbolic, or elliptical shape. The arc-shaped working edge is advantageously constituted by the circumference of a circle around whose center point the fastening means is situated, in particular centered in the circle. With this design, when the output shaft of the handheld power tool oscillates, no vibration is imparted to the tool unit in the advancing direction or in the direction perpendicular to the working edge. In addition, this permits the tool unit to be used in a comparatively stable, multifunctional fashion. The circular design permits the tool unit, through simple rotation of the handheld power tool, to be used to machine a work piece, e.g. for grinding, cutting, sawing, clearing, or disk cutting.

If the angle between the working edge and the lateral boundary line is 90°, then the above-described advancing of the tool unit produces a right angle between the bottom of the cut and the lateral cut edge. If the angle is less than 90°, then the tool unit can even produce an acute angle between the cut bottom and the cut edge. An angle of at most 5° greater than 90° is still tolerable due to the oscillation of the working edge. With an angle of greater than 95°, the above-described advantage is no longer achieved.

The tool unit itself—apart from the angle between the working edge and the lateral boundary line—can have virtually any outer form depending on the area in which it is to be used and on the respective handheld power tool. In particular, the tool unit can also be embodied as goosenecked.

In another advantageous embodiment, the arc-shaped working edge is constituted by the circumference section of a circle sector; each of the two ends of the working edge is situated at an angle in relation to a respective lateral boundary line extending in the radial direction. The angle between the two lateral boundary lines that define the circle segment should advantageously lie between 30° and 270°. If the angle is smaller, then the tool unit is susceptible to change with regard to the required length of the working edge in relation to the length of the boundary line required here. With a larger angle, the cut produced by the tool unit can only be of limited depth.

For the mechanical stability of the tool unit, it is useful for the radially extending boundary lines to be connected to each other by means a connecting contour before they reach the center point. This connecting contour can be embodied in almost any way, in particular with arc-shaped transitions. Embodying the tool unit with a connecting contour also leaves more space available for the attachment of the fastening means.

The arc-shaped working edge is advantageously constituted by the circumference section of a circle segment; each of the two ends of the working edge is situated at an angle in relation to a respective boundary line, each of which is essentially constituted by the straight section of the circle segment. With a large radius of the circle segment, this design permits particularly deep cuts to be made. The circle segment can be laterally elongated in a corresponding fashion in order to attach the fastening means.

The working edge is the one that is used to machine the work piece. The working edge is responsible for advancing the tool unit and can be embodied in numerous ways. Depending on its intended use, it can be embodied as a sharp cutting edge or can be provided with a rough or abrasive covering such as diamond or corundum. The edge itself can also be embodied as flat or broad in order to act on a work piece in a for example grinding or machining fashion. For a perpendicular cut into a work piece, it is particularly advantageous if the working edge is provided with saw teeth.

Additional advantages ensue from the following description of the drawings. The drawings show exemplary embodiments of the present invention. The drawings, the specification, and the claims contain numerous defining characteristics in combination. Those skilled in the art will also consider these defining characteristics individually and unite them in other meaningful combinations.

### BRIEF DESCRIPTION OF THE DRAWINGS

FIG. 1 shows a tool unit with a working edge in the form of an ellipsoidal arc used for carrying out a method of machining in accordance with the present invention,

FIG. 2 shows a tool unit in the form of a circle segment, with a connecting contour used for carrying out a method of machining in accordance with the present invention,

FIG. 3 shows another tool unit in the form of a circle segment used for carrying out a method of machining in accordance with the present invention.

### DESCRIPTION OF THE PREFERRED EMBODIMENTS

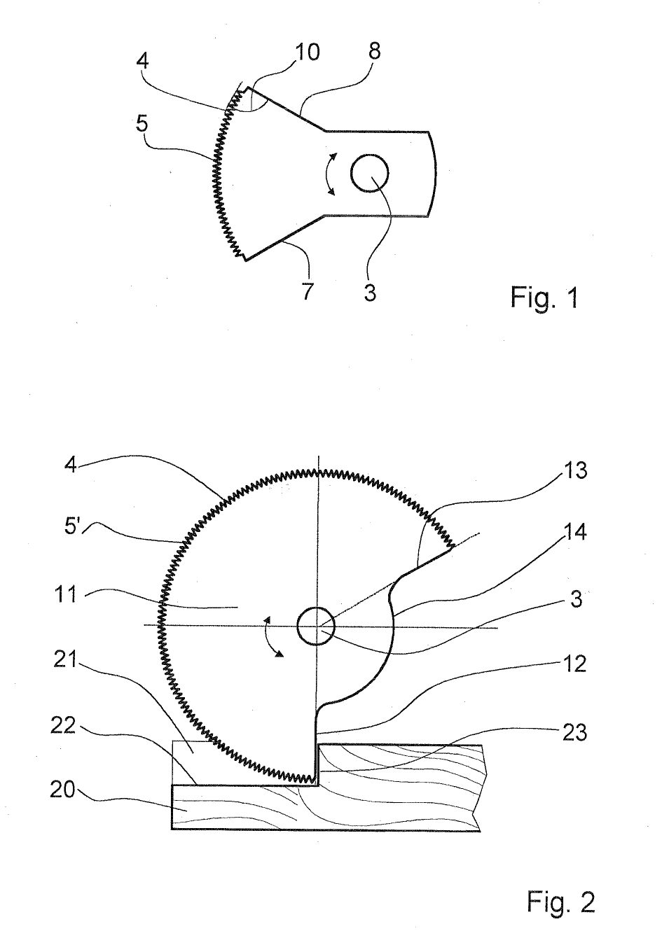

FIG. 1 shows a tool unit for a handheld power tool with an oscillating output shaft that makes it possible to produce a perpendicular cut in a work piece. The tool unit has an opening or bore that accommodates the output shaft of the handheld power tool. The oscillating, rotary motion of the output shaft moves the tool unit back and forth between two angular positions, as is schematically depicted by the arrows. In this manner, a work piece is machined by means of a working edge 4 equipped with saw teeth. The oscillation range measures 4°.

The working edge 4 is embodied in the form of an ellipsoidal arc 5, each of whose ends is situated at an angle 10 of 90° in relation to the lateral boundary lines 7 and 8. In this way, as the tool unit produces a cut, at each of the lateral defining lines 7 and 8, a clean corner is cut from the work piece, with a 90° angle between the bottom of the cut and the edge of the cut.

The tool unit according to FIG. 2 is embodied in the form of a circle sector 11, which has a fastening means 3 in the form of a bore at the center point of the circle to accommodate the output shaft of a handheld power tool. The circle sector 11 is essentially comprised of the working edge 4, which has the form of a circular arc 5′, and two lateral boundary lines 12 and 13 extending in the radial direction. The boundary lines 12 and 13 are connected to each other via a connecting contour 14 that has arc-shaped connections.

FIG. 2 also shows a machined work piece 20. The cut 21 that the tool unit produces in the work piece 20 is clearly visible. The cut 21 has a cut bottom 22 and a cut edge 23. The right angle between the working edge 4 and the lateral boundary line 12 of the tool unit produces a likewise right angle between the cut bottom 22 and the cut edge 23. No residual material of the work piece 20 is left in the corner.

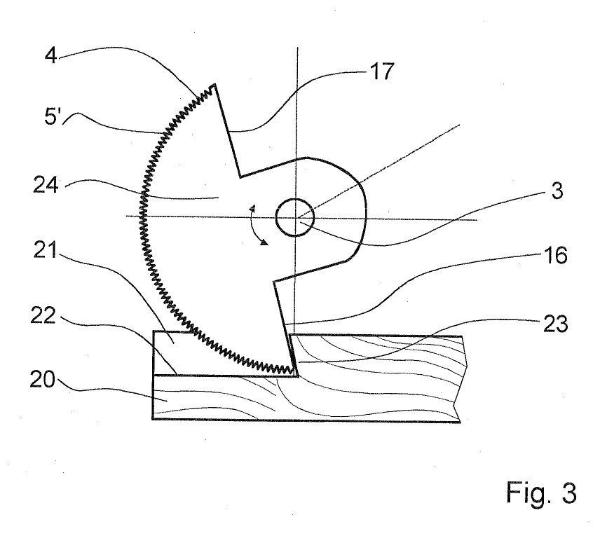

The working edge 4 of the tool unit according to FIG. 3 is part of the circumference of a circle segment 24 that is comprised of the working edge 4 and lateral boundary lines 16 and 17 lying on a straight line. An extension contains a fastening means once again embodied as a bore situated at the center point. It is clear that the angle of less than 90° between the working edge 4 and the lateral boundary line 16 makes it possible to produce a cut 21 in the work piece 20 in which there is an acute angle between the cut bottom 22 and the cut edge 23.

It will be understood that each of the elements described above, or two or more together, may also find a useful application in other types of methods differing from the types described above.

While the invention has been illustrated and described as embodied in a method of machining with a tool unit, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A method of machining, comprising the steps of providing a tool unit for a handheld power tool having an oscillating output unit, a fastening means for attachment to the output unit, and a working edge transitioning into a lateral boundary line, being arc-shaped, and constituted by a circumference of a circle around whose circle point the fastening means is situated; situating at least one end of the working edge at an angle of substantially 90° in relation to a lateral boundary line on at least one side and constituting the working edge by a circumference section of a circle sector, and situating each of two ends of the working edge at an angle in relation to a respective lateral boundary line extending in a radial direction; and in a vertical guide as the tool unit advances along the lateral boundary line situating a deepest point of an advancing motion in a corner between the arc-shaped working edge and the lateral boundary line, and so that between a bottom of the guide and the lateral cut edge there is not any residual cross-section of the workpiece.
